(19) United States
(12) Patent Application Publication
(10) Pub. No.: US 2001/0040181 A1
(43) Pub. Date: Nov. 15, 2001

(54) Envelope for non-impact printer

(76) Inventor: Warren M. Fabel, Delray Beach, FL (US)

Correspondence Address: TED W. WHITLOCK, REGISTERED PATENT ATTORNEY, P.A., 5323 SW. 38TH AVENUE, FT. LAUDERDALE, FL, 33312, US

(21) Appl. No.: 09/911,013

(22) Filed: Jul. 23, 2001

Related U.S. Application Data
(63) Continuation-in-part of application No. 09/267,305, filed on Mar. 12, 1999.

(51) Int. Cl. B65D 27/14; B65D 27/00; B41F 21/12

(52) U.S. Cl. 229/68.1; 229/80; 101/485; 101/486

(57) ABSTRACT

An article of manufacture and method for printing, using a non-impact printer, indicia less than ¼″ from an edge of the article of manufacture is disclosed. The article of manufacture and method can provide for positioning printed information on the article of manufacture in accordance with United States Postal Service specifications. The article of manufacture, e.g., a document such as an envelope or other form, includes an extension portion forming an edge detectable by a page detecting means of a non-impact printer wherein the detectable edge extends past the actual edge of the article so that the non-impact printer is directed to print less than ¼″, and preferably less than 1/8″, from an actual edge of the article of manufacture.

### CROSS-REFERENCE TO RELATED APPLICATIONS

This is a continuation-in-part of pending U.S. patent application Ser. No. 09/267,305 filed Mar. 12, 1999 and its Continued Prosecution Application filed Feb. 15, 2001.

### FIELD OF THE INVENTION

This invention generally relates to printed documents, and more specifically, to envelopes which can be printed, using a non-impact printer, with information or coding in accordance with United States Postal Service requirements.

### BACKGROUND OF THE INVENTION

Non-impact printers, such as laser or ink-jet printers, are being increasingly used to provide a fast, economical, and convenient method of printing data developed within computer systems and stored in databases. An important example of this kind of data includes mailing lists for the distribution of correspondence, billings, or other information. In most organizations, preparing and distributing mail represents a significant effort.

The United States Postal Service (USPS), in its efforts to provide more efficient services, is continually improving its direction toward automating distribution procedures. With this automation, the USPS has developed strict specifications for the indicia provided on an envelope. For example, in the area of business reply mail (BRM), the USPS has set requirements for the size and location of various indicia, including but not limited to the business reply legend box, postage paid line, address format, POSTNET barcode location, postage endorsement indicia, horizontal bars, and the facing identification mark (FIM).

A FIM pattern is required on all BRM postcards and letter-sized mail pieces. According to USPS specifications, a FIM clear zone must contain no printed matter other than the FIM pattern. FIM bars must be between 1/2″ and 3/4″ high and 0.03125 (1/32 of an inch) ±0.008″ wide. The specifications further require that the FIM area is 1¼″ wide×5/8″ high. The left edge of a FIM clear zone must be 3″ from the right edge of the envelope and the right edge of the FIM clear zone must be between 1⅞″ to 2⅛″ from the right edge of the envelope, preferably The requirement that the FIM begin no less than 1/8″ from the top of an envelope is disadvantageous for the use of non-impact printers, especially laser printers, which cannot print less than 1/4″ from the edge of a page. Therefore, the task of automating the printing of envelopes or other postal forms using a non-impact printer can present a problem in meeting the USPS requirements. The printing of indicia no more than c″ from the edge of an envelope face is not limited to the FIM. Other indicia, including, for example, postage endorsement indicia, must also be printed within 1/8 from the edge of an envelope in order to meet certain USPS specifications. Accordingly, use of a non-impact printer which is capable of printing no less than 1/4″ from an edge of a page does not adequately address the problem of printing an envelope in accordance with those USPS specifications. Typically, indicia is required to be printed within 1/8″ of two or more edges of an envelope. Thus, as certainly available, use of a non-impact printer to print indicia on a standard envelope will not meet USPS requirements.

### BRIEF SUMMARY OF THE INVENTION

It is an object of the instant invention to provide a method and article of manufacture which allows printing on an envelope, using a non-impact printer, indicia which meet United States Postal Service (USPS) requirements. More specifically, the method and article of manufacture according to the subject invention allows printing, using a non-impact printer, postal indicia within 1/8″ of an edge of the envelope.

The article of manufacture according to the subject invention includes an envelope wherein at least one edge of the envelope has a removable strip forming an extension which can indicate to the paper or page detecting means of a non-impact printer that the detected edge of the envelope extends beyond the actual edge of the envelope. This extension can be formed from, be part of, or be coextensive with the envelope “sealing” flap which is the flap that folds over the opening of the envelope.

Typically, the sealing flap includes an adhesive for sealing the envelope. However, for use with a non-impact printer, e.g., a laser printer which can create a relatively high degree of heat when operated, a protective strip must cover the adhesive so that the heat of the non-impact printer does not compromise the adhering property of the adhesive. In one embodiment of the subject invention, the protective strip covering the adhesive comprises an extension portion forming a detectable edge which extends beyond at least one actual edge of the envelope. Preferably, the extension portion is positioned such that the detectable edge activates the page detecting means, e.g., mechanical or photocell page detector, in a non-impact printer. In a preferred embodiment, the extension portion is removably attached to the envelope. In a further preferred embodiment, the envelope comprises a self-seal adhesive which advantageously can eliminate a need for sealer mechanisms typically provided on conventional automated postal meters.

Other configurations for the subject article of manufacture, wherein an envelope is provided with a removable strip which can activate a page detecting mechanism in a non-impact printer such that a detectable edge of the envelope extends beyond its actual edge, would be readily recognized by persons of ordinary skill in the art. Thus, by employing an article of manufacture according to the subject invention, a non-impact printer can be activated to print indicia 1/8″ or less from the actual edge of the document, e.g., an envelope, because the printer is printing at 1/4″ or more from the detected edge of the document.

The method of the subject invention comprises providing a document, e.g., an envelope having an extension portion forming a detectable edge of an envelope which extends past the actual edge of the envelope and printing indicia on said document less than 1/4″ from the actual edge of the document. Preferably, the subject method comprises printing indicia on a document, using a non-impact printer in a standard fashion, at 1/8″ or less from the actual edge of the document.

### BRIEF DESCRIPTION OF THE DRAWINGS

FIG. 1 shows a plan view of a front face of an embodiment of the article of manufacture according to the subject invention.

FIG. 2 shows a plan view of a back face of an embodiment of an article of manufacture according to the subject invention.

FIG. 3 shows a plan view of an inner face of an embodiment of an article of manufacture according to the subject invention, in an unfolded configuration.

FIG. 4 shows a plan view of a embodiment of an article of manufacture according to the subject invention, illustrating a facing identification mark (FIM) on a front face of the article.

FIG. 5A shows a plan view of a back face of an embodiment of an article of manufacture according to the subject invention, illustrating the removable strip extension portion.

FIG. 5B shows a plan view of a front face bearing various indicia of an embodiment of an article of manufacture according to the subject invention, and the removable strip extension portion separated from the article.

FIG. 6 shows a plan view of a back face of a side-seam envelope embodiment of an article of manufacture according to the subject invention.

FIG. 7 shows a plan view of a back face of an edge-glue embodiment of an article of manufacture according to the subject invention.

### DETAILED DESCRIPTION OF THE PREFERRED EMBODIMENTS

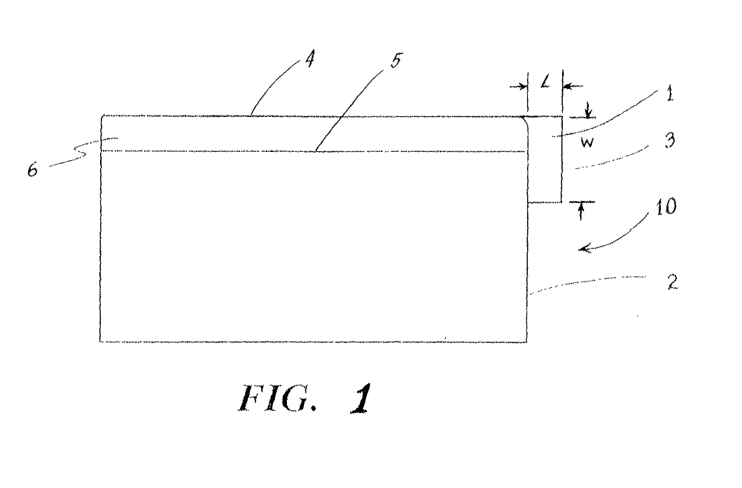

Referring now to the drawings, FIG. 1 shows an embodiment of an article of manufacture according to the subject invention comprising an envelope 10 which includes an extension portion 1 forming a detectable edge of the envelope which extends beyond an actual edge of said envelope. Specifically shown in FIG. 1 is an embodiment wherein the extension portion 1 comprises a strip which extends past the leading actual edge 2 of the envelope 10 at distance L to form a leading detectable edge 3. The strip extension portion 1 also forms a top detectable edge 4 which extends distance W, which is at least past a top actual edge 5 of said envelope. FIG. 1 shows particular dimensions of the extension portion 1 for exemplary purposes only. The dimensions of the extension portion of the subject article of manufacture are not critical to the invention and can be of any convenient size or dimension so long as the extension portion is capable of performing the function of activating the page detecting means of a non-impact printer.

The strip extension portion 1 is preferably removable from the sealing flap 6 so that, upon removal, a standard envelope with sealing flap remains. The removable strip portion 1 can be detachably affixed to the sealing flap along edge 4, e.g., affixed by a perforated juncture, or can be a separate layer detachably affixed to a pressure-sensitive adhesive disposed on an inner face of the sealing flap.

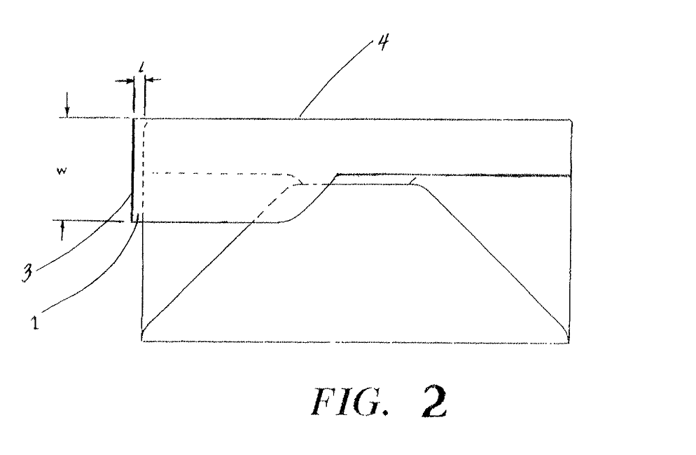

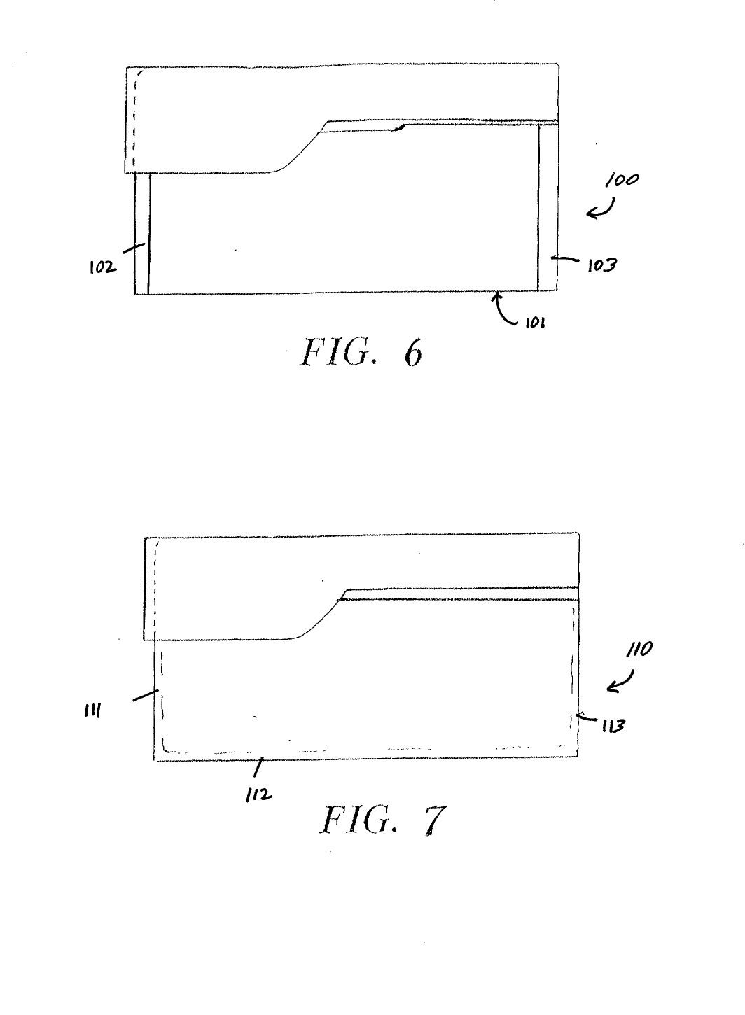

FIG. 2 shows, in plan view, a back side of the envelope 10 as shown in FIG. 1, illustrating the removable strip extension portion 1 forming a detectable leading edge 3 extending length, L, beyond actual leading edge 2 of the envelope 10; and top detectable edge 4 extending width W, at least past the top actual edge (not shown) of said envelope. Illustrated in FIG. 2 is a diagonal seam envelope. However, such configuration is shown throughout this description for exemplary purposes only. It would be understood that this invention is readily applicable and adaptable to other envelope configurations, including side-seam (see FIG. 6) and edge-glue (see FIG. 7) envelope configurations, as well as other documents, e.g., forms or pages in need of printing indicia on a non-impact printer less than 1/4″ from an edge of the document.

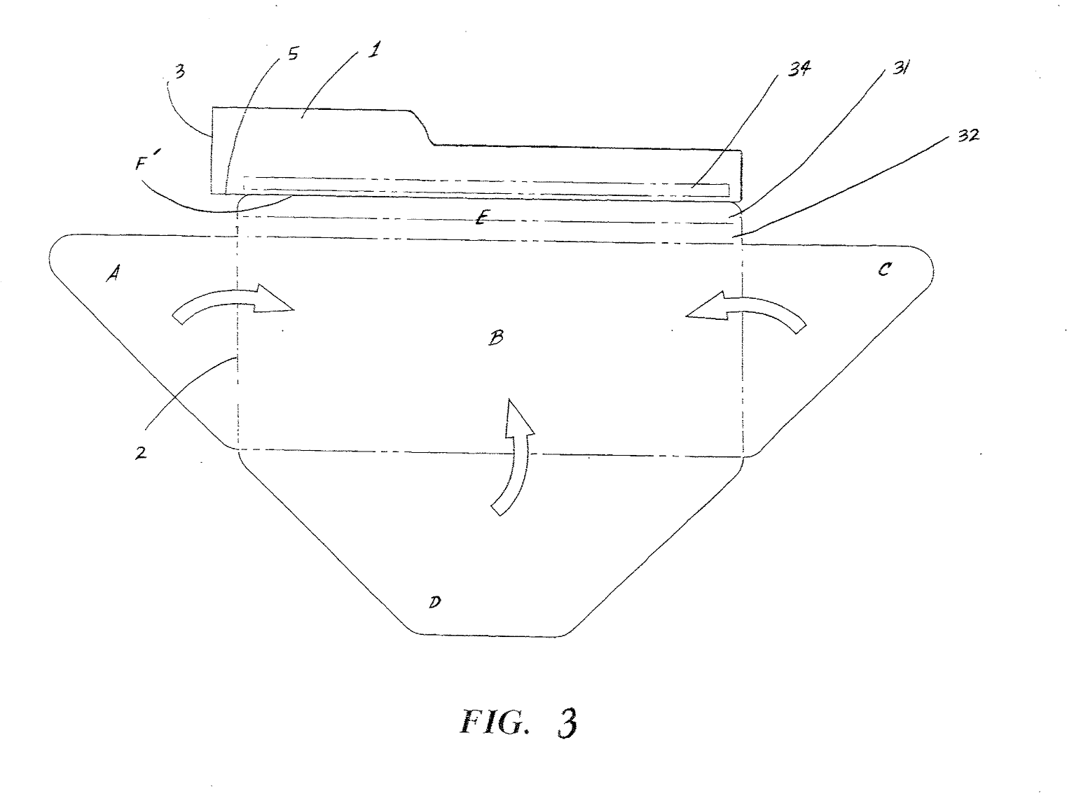

FIG. 3 illustrates an extended, or non-folded, configuration of an envelope according to the subject invention, wherein panel B is the inner face of the envelope panel on which the postal indicia is printed. In forming the envelope according to the subject invention, flaps A, C, and D are folded, as indicated by the open arrows, to substantially cover face B. Flaps A, C, and D are adhered to one another according to standard procedures and using standard permanent adhesive. Adhesive area 31, is shown whereon adhesive for sealing the envelope is disposed on or applied to sealing flap 32, at face E. Typically, adhesive is disposed along an outer edge of sealing flap 32 such that an area along the extreme outer edge of the sealing flap 32 remains free of adhesive. This adhesive-free area is provided so that heat generated by the printing process, e.g., the fusion stage of a typical laser printer, does not cause the adhesive to melt or otherwise run or bleed past the edge of the sealing flap such that other areas of the envelope or printer mechanism become contaminated by adhesive. Typically, the adhesive-free area is about 1/16″ wide along the outer edge of the sealing flap.

In a preferred embodiment, the adhesive applied to the sealing flap 32 is a pressure-sensitive adhesive. The removable strip extension portion 1 is shown as being connected to or substantially coextensive with the outer edge of the sealing flap 32. An adhesive-release material 34, e.g., silicone, can be applied to the removable strip extension portion 1 in a pattern which substantially corresponds to the adhesive area 31 on face E of the sealing flap 32. In manufacture, the removable strip extension portion 1 can be folded over face E of the sealing flap 32, along fold line F′. Fold line F′ can be perforated, trimmed, or slit to form a readily removable strip extension portion 1 and the sealing flap 32.

In use, the article of manufacture according to the subject invention is fed into a non-impact printer such that the leading detectable edge 3 and top detectable edge 4 activate the paper or page detecting means of a non-impact printer. The removable strip extension portion 1 can be made from any standard material and is preferably a material which is identical to, or compatible with the envelope material. In one embodiment, the extension portion is made of a material which is more rigid than the envelope material in order to facilitate feeding into a printer automatic feed mechanism. Preferably the extension portion material is rigid enough to activate a mechanical stop mechanism on a non-impact printer.

When the envelope of the subject invention is fed through a non-impact printer, the subject invention advantageously allows indicia to be printed on the face of the envelope at less than 1/4″ from the leading actual edge 2 or top actual edge 5 of the envelope. Preferably, the article of manufacture according to the subject invention allows indicia, e.g., a FIM pattern 41, to be printed at 1/8″ or less from an actual edge of the envelope, and more preferably can be printed up to the actual edge of the envelope 10 (FIG. 4).

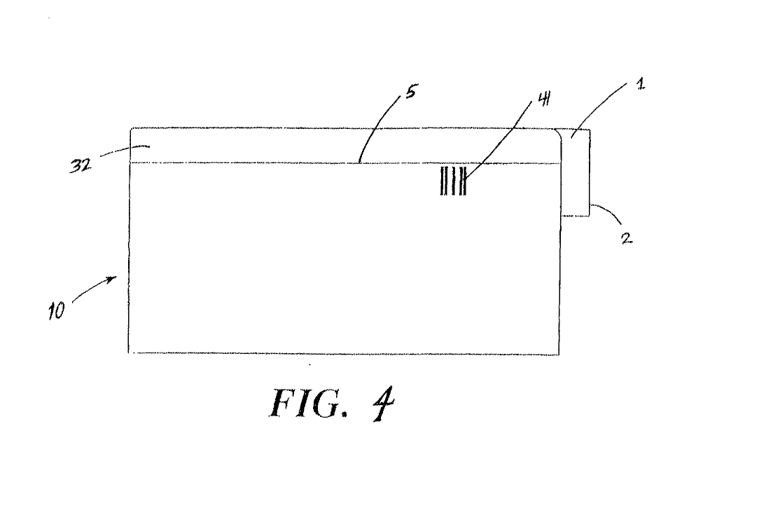

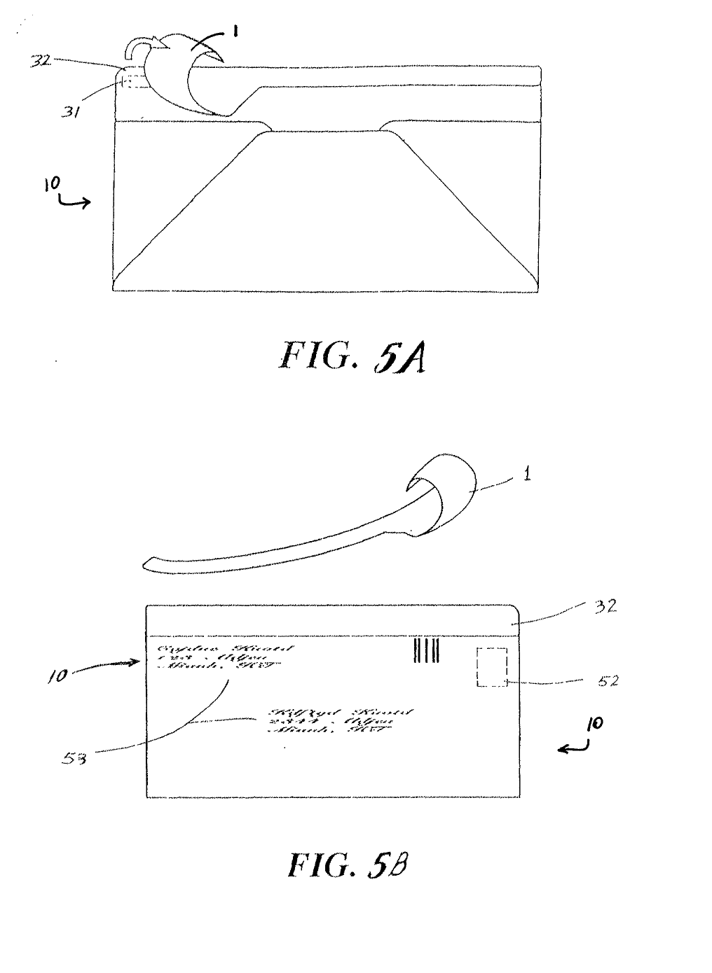

Once the indicia are printed, the removable strip extension portion 1 can be removed from the adhesive area 31 on the face of the sealing flap 32 for sealing the envelope. See FIGS. 5A and 5 which show the removable strip portion 1 being partially separated (FIG. 5A), then completely separated (FIG. 5B) from the envelope 10. Specifically, FIGS. 5A and 5B show the removable strip portion 1 separated from the sealing flap 32 to expose the underlying adhesive area 31.

The subject invention thus provides an envelope, useful as a standard envelope, on which indicia such as address information, FIM pattern, bar code indicia, postage endorsement indicia, or the like, can be printed on or near an edge of the envelope. The subject invention is not intended to be limited to the envelope styles described herein, and is readily applicable to envelopes of various styles, shapes or sizes. For example, the subject invention can be employed with an envelope known in the art as a side-seam envelope 100 which is a single ply folded to form a bottom edge, then sealed, typically using a standard permanent adhesive material, along both side edges 102 and 103, as illustrated in FIG. 6. Alternatively, the subject invention can be employed with an envelope known in the art as an edge-glue envelope 110, which is two plies that are joined and sealed, typically using a standard permanent adhesive material, along three perimeter edges 111, 112, and 113, as illustrated in FIG. 7.

It should be understood that the examples and embodiments described herein are for illustrative purposes only and that various modifications or changes in light thereof will be suggested to persons skilled in the art and are to be included within the spirit and purview of this application and the scope of the appended claims.

I claim:

1. An article of manufacture printable on a non-impact printer, said article comprising an envelope portion and a removable strip which extends beyond a leading edge of the envelope portion, said leading edge being defined as the edge first fed into a document feeder mechanism of a non-impact printer, such that the extending strip is detected by a non-impact printer as an actual edge of the envelope portion, thereby shifting the printing field toward the actual edge of the article.

2. The article of claim 1 wherein said removable strip is integral with a sealing flap of said envelope.

3. The article of claim 2 wherein said removable strip forms a protective cover over an adhesive disposed on the sealing flap.

4. The article of claim 3 wherein said removable strip has adhesive release material disposed on a face opposing an adhesive-disposed face of the sealing flap.

5. The article of claim 1 wherein said strip is detected by a page detection means of the printer.

6. The article of claim 1 whereby said detected removable strip enables printing of indicia on the article less than 1/40 inch from the actual edge of said article.

7. The article of claim 1 whereby said detected removable strip enables printing of indicia on the article less than 1/80 inch from the actual edge of said article.

8. The article of claim 6 wherein the printed indicia is a face-indicating mark (FIM) required by the US Postal Service.

9. A method for printing with a non-impact printer less than 1/4 inch from an edge of a printable article, said method comprising:
providing a printable article comprising an envelope portion and a removable strip which extends beyond a leading edge of the envelope portion, said leading edge of said envelope portion being defined as the edge first fed into a document feeder mechanism of a non-impact printer, such that the extending strip is detected by a non-impact printer as an actual edge of the envelope portion, thereby shifting the printing field toward the actual edge of the article;
processing said article through a non-impact printer.

10. The method of claim 9 wherein said removable strip is integral with a sealing flap of said envelope.

11. The method of claim 10 wherein said removable strip forms a protective cover over an adhesive disposed on the sealing flap.

12. The method of claim 11 wherein said removable strip has adhesive release material disposed on a face opposing and adhesive-disposed face of the sealing flap.

13. The method of claim 9 wherein said strip is detected as an actual edge of the envelope portion by a page detection means of the printer.

14. The method of claim 9 whereby said detected removable strip enables printing of indicia on the articles less then 1/4 inch from the actual edge of said article.

15. The method of claim 9 whereby said detected removable strip enables printing of indicia on the article less than 1/8 inch actual edge of said article.

16. The method of claim 9 wherein the printed indicia is a face-indicating mark (FIM) required by the US Postal Service.
